(19) United States
(12) Patent Application Publication
(10) Pub. No.: US 2013/0332600 A1
(43) Pub. Date: Dec. 12, 2013

(54) SYSTEM FOR MONITORING ONLINE INTERACTION

(71) Applicants: Antonio Manuel Amaya Calvo, Madrid (ES); Ivan Sanz Hernando, Madrid (ES); Romero Bueno, Madrid (ES)

(72) Inventors: Antonio Manuel Amaya Calvo, Madrid (ES); Ivan Sanz Hernando, Madrid (ES); Romero Bueno, Madrid (ES)

(21) Appl. No.: 13/807,215

(22) PCT Filed: Jul. 6, 2011
(86) PCT No.: PCT/EP2011/061362

§ 371 Date: Aug. 15, 2013

(30) Foreign Application Priority Data
Jul. 6, 2010 (ES) P201031032

(51) Int. Cl. H04L 12/26

(52) U.S. Cl. CPC H04L 43/08
USPC 709/224

(57) ABSTRACT

A system for monitoring online communications of at least one LAN user, specially useful for controlling children's internet interactions. The system comprises a central communications server and locally deployed equipment in the user's home LAN, the locally deployed equipment comprising means adapted to automatically enumerate and store all the peers of the local user, analyze natural language of the conversations between the user and the peers to assign an age range of the peers through morphological and syntactical language use, identify customer-specified words and generate a network of peers and alarms for users according to previously determined rules; and the central communications server comprising means to collect anonymized data from the pairs.

### FIELD OF THE INVENTION

The invention relates to applications that monitor internet interactions of underage users with external peers, to avoid privacy threats, children being molested by other peers, etc.

### STATE OF THE ART

Internet eases establishing relationships with other persons, both known and unknown, children and adults. On those relationships it is easy to hide the real identity of the peers, and thus the risk of underage children to be molested by other persons is higher. According to some statistics, around 30% of the children have given their phone number during an online conversation, 16% have given their physical address and 15% have concerted a meeting with an unknown person. Currently, the solution to these problems implies either filtering or blocking the unwanted content or monitoring the Internet usage. To aid in both tasks, there exist a number of tools that implement filtering and monitoring services. These tools can be divided into two groups:
Applications that have to be installed on the end-point (computer solutions). They usually have more functionality that their network counterparts, as they can monitor and filter more types of content, but they need to be installed on each computer. Applications of this kind are even able to log keystrokes or capture screenshots of normal computer usage.
Applications that reside on the network (network solutions). This kind of applications work by intercepting communications at network level, so sometimes they need to be configured as web proxy on the client computers and sometimes they work transparently just by sitting on the network path between the client computers and the services. Applications of this kind are usually more restricted on what they can monitor and/or block.

The computer solutions present the disadvantages that are difficult to install and manage for residential customers, and monitoring consist in logging all interactions, being thus very intrusive on privacy. Furthermore, they can be easily deactivated locally in the computer and monitoring is manual, that is, somebody actually has to read all the logged conversations, which is time consuming and involves a privacy violation.

The network solutions usually only restrict or monitor access to web services, so all the IM protocols where most of the danger resides are usually exempt of monitoring. Restriction is usually location based, so that users that access the internet outside their home are unprotected. Besides, if there is monitoring implemented and not just blocking the application logs have to be manually revised to take corrective measures.

### SUMMARY OF THE INVENTION

The invention aims to solve the problems posed above by providing a system for monitoring online interactions of a LAN comprising a central communications server and locally deployed equipment as claimed. Further advantageous embodiments are incorporated in the dependent claims.

### BRIEF DESCRIPTION OF THE DRAWINGS

To complete the description and in order to provide for a better understanding of the invention, a set of drawings is provided. Said drawings form an integral part of the description and illustrate preferred embodiments of the architecture for implementing the method of the invention, which should not be interpreted as restricting the scope of the invention, but just as an example of how the invention can be embodied.

FIG. 1 depicts the system of the invention.

FIG. 2 shows the system architecture.

FIG. 3 is a flowchart of the SSL tunnelling mode process.

FIG. 4 is a flowchart of the Pluggable Protocol Analyzer function.

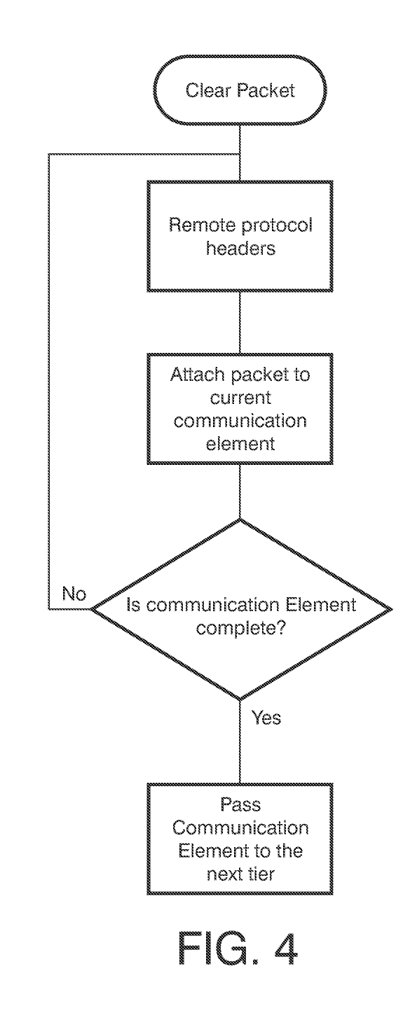

### DESCRIPTION OF THE INVENTION

The system consists on locally deployed equipment (hardware and software) and a central communication server. Locally deployed equipment will have access to all the online communication data, but will share with the central communication server only some information (anonymized) not including any actual private data (no conversation data will be transmitted).

The system works analyzing automatically the conversations and will have the following functionalities:
Automatically enumerate and store all the peers of local users. Peers are any kind of identity of a remote entity (chat login name, web service URL, social network identity, etcetera).
Automatically analyze interactions (conversations) with IM peers.
Peers will be assigned an automatic age range calculated by natural language analysis (morphological and syntactical) of their conversations.
Identify customer-specified keywords.
No conversation will be stored
Automatically generate a network of contacts for protected users. The network can include information from other nodes, by using the central communication server
Generate alerts when some customer-configured event occurs.

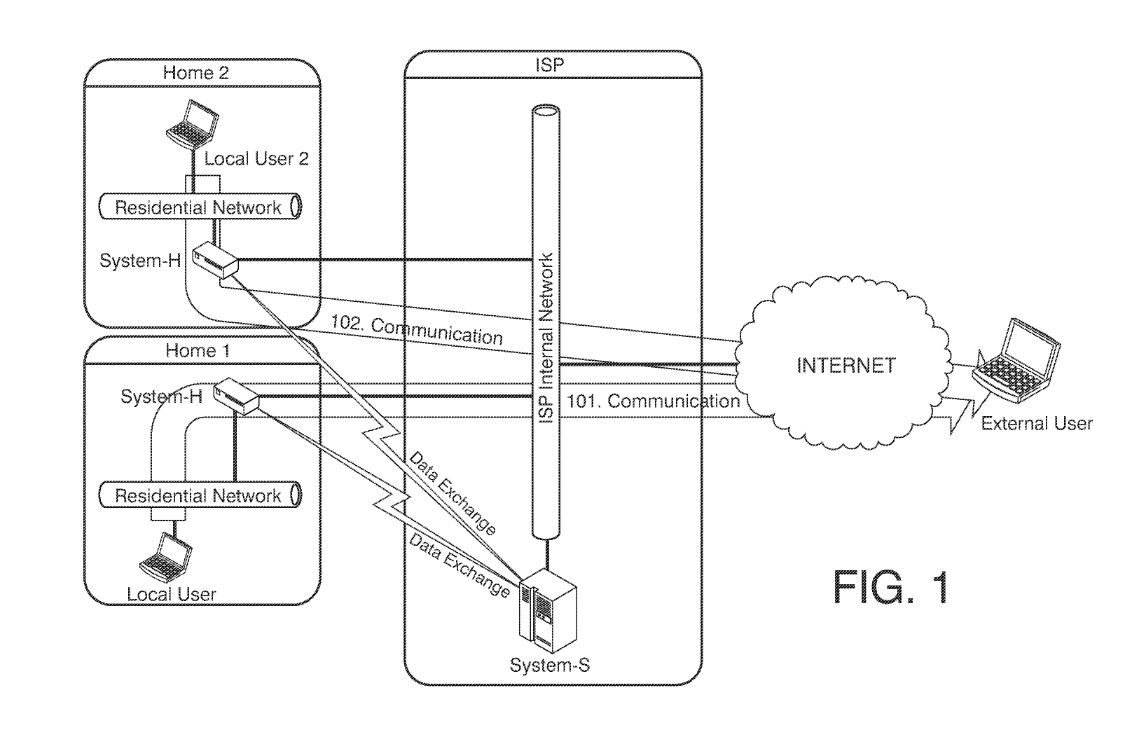

FIG. 1 shows a simplified architecture of the proposed system. Home 1 and Home 2 are two typical residential scenarios, that have a local area network with one or more computers plugged to it. Local User 1 (LU) and Local User 2 (LU2) are residential users, customers of the ISP that has implemented the system of the invention. System-H represents the aforementioned ‘locally deployed equipment’, the network monitoring component of the system. System-S represents the aforementioned ‘central communication server’, the customization and coordination component of the system. External User(EU) represents any user that's either completely out of the ISP network or just out of the invention's monitoring network.

On FIG. 1, Local User 1 (LU1) and Local User 2 (LU2) have established a communication with External User. Although network direct communication as shown in the image is rare (on IM systems a central communication system will be used to actually execute the message exchange, for example), conceptually the communication can be assumed to be direct (at least regarding personal message exchanging).

System-H on Home 1 will detect the communication (101) and start analyzing it. Besides, it will identify the LU's peer (EU) and will ask System-S for more information about EU.

System-H on Home 2, will also detect the communication (102) and start analyzing it. Besides, it will identify LU2's peer (EU) and will ask System-S for more information about EU.

Originally System-S will not have any information about communication networks. Once System-H from Home 1 and Home 2 have asked about EU, though, System-S will know that EU is communicating with both LU and LU2 and will inform so to System-H from Home 1 and Home 2. This information will also be stored, in anonymized form, for future use.

On the Figures, ISP Internal Network is shown only as to specify that System-S will be installed as part of an internal network belonging to the ISP, without direct access to the Internet. System-S will not require any further interaction with the ISP network or any other ISP service or system.

This way, each System-H component will store a communication network for its users, and System-S will have a (anonymized) complete communication network for all users. It's important to note here that the user identifier used on the communication network will be the actual user identifier used on the underlying communication system. For example, if the communication is a Jabber chat, the Jabber identifier will be used.

System-H, will sit between the local area network and the Internet Access, implementing the following functionality:
Implement a web user interface to allow the administration, customization and exploitation of gathered data.
Intercept all network communication passing through it. The system will not proactively block any communication.
Analyze network protocols. To this extent, System-H will implement a pluggable protocol analyzer.
For protocols that aren't interactive, defining interaction as having a person-to-person communication (for example, HTTP) the system will realize a number of analysis (based on pluggable analyzers). Analysis of the transmitted and received content will include:
   Search for specific keywords on the content.
   Natural language analysis of the content to detect dangerous or forbidden content proactively.
   Detect if the peer is included on a black-list of forbidden or dangerous sites.
   Identity of a peer on a non-interactive communication is established as follows:
      If the service is anonymous/impersonal, then the identity is the own service. For example, identity for www.amazon.com it's Amazon.
      If the service is a personal/social network or similar, then the identity is the identity of the owner of the visited page. For example, identity for a profile on Facebook will be the profile's owner identity.
For protocols that are interactive, additional analysis are performed:
   Identities for all the peers on the conversation are extracted.
   Natural language analysis of the communication, both outgoing and incoming is done, to detect dangerous situations proactively.
   Specific keywords may be looked upon in the communication.
   Based on natural language usage (morphological and syntactical language usage) a preliminary age range is assigned to each peer of the communication.
Additional information for the peers (based on the identity from the analysis) is queried from System-S. The information is added to a ‘communication network’. A communication network is a directed graph structure that has as starting node the identity of the local user. Nodes of the graph are other users, and a link exists between two users if both users are communicating currently or have communicated on the past.
Generate alarms, based on all the information gathered and deduced. Alarms can be distributed by several methods, such as: email, SMS, phone call, . . . .

System-S, will implement the following functionality:
Act as communication hub for System-H components. The protocol used for message communication between System-H and System-S can be SOAP over HTTPS.
Collect anonymized information from identity pairs gathered by System-H components. An identity pair is a pair of identities that have a known relationship (meaning they have communicated in the past).
Centrally update software installed in System-H components.
Detect when a controlled user (i.e., an internal user protected by the system) is accessing the network from a non protected location and propagate that information to the local System-H component for that user.

When a protected user (child) accesses the network from a protected location (normally his/her home) the process will be as follows, for each communication he/she establishes:
1) System-H will detect the communication and allow it to proceed.
2) Once System-H has enough information to gather identities from the communication, it will ask System-S for additional information about the collected identities. This step is always performed, even if System-H already has previous information for that identity.
3) It's important to note that if System-S detects that an identity that has been asked about in step 2 is a ‘protected’ identity (a identity the system knows belongs to a protected user), then it will check if the identity has been used from its protected location and send a warning to the associated System-H otherwise.
4) System-H analyzes the conversation, using natural language analysis, and updates the age information for each peer.
5) The system evaluates if it has to generate an alarm, based on a customizable rule using:
   a) Estimated Age of Peers (where applicable)
   b) Content of the conversation with peers
   c) Detection of specific keywords
   d) Information about the ‘communication network’ for peers.

The alarm will include the details of why the alarm was generated, but no actual conversation data will be included, to protect the privacy of all parts involved

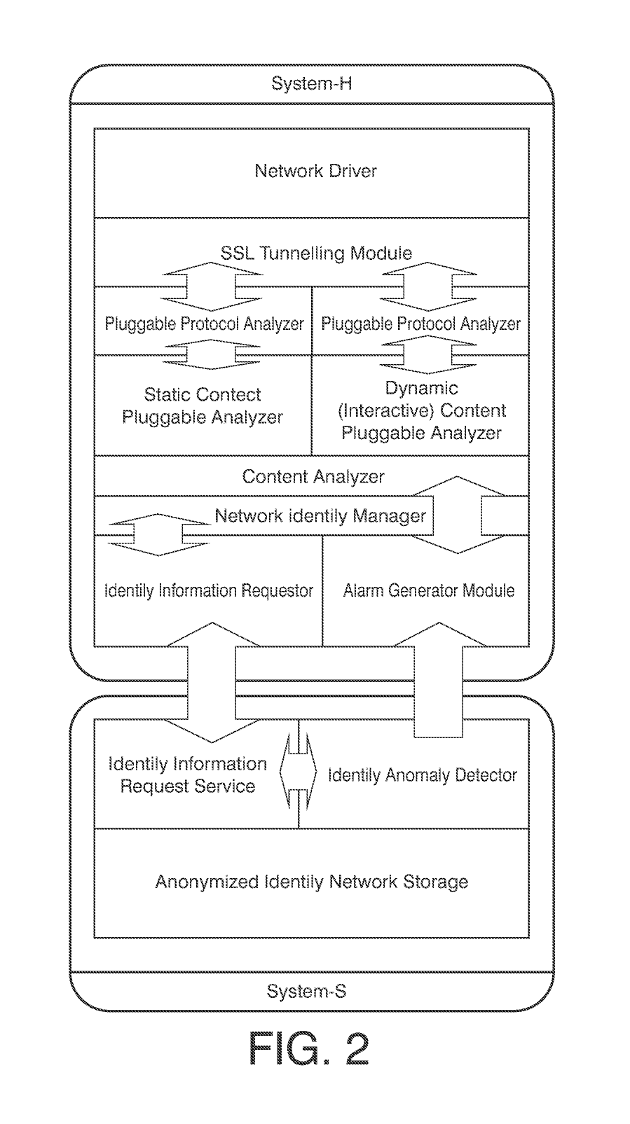

The System-H can include the following modules (FIG. 2):

### Network Driver.

This module, existing in previous art, will act as interface to the physical network, to allow the capture of all network packets so they can be analyzed. For most protocols the module will act as a passive probe, since no network data will be modified. However, for protocols implemented over SSL, the connection will be intercepted, as described further on.

### SSL Tunneling Module.

This module will allow the interception of encrypted connections that use the SSL/TLS protocol (for example, HTTPS or XMPP over SSL).

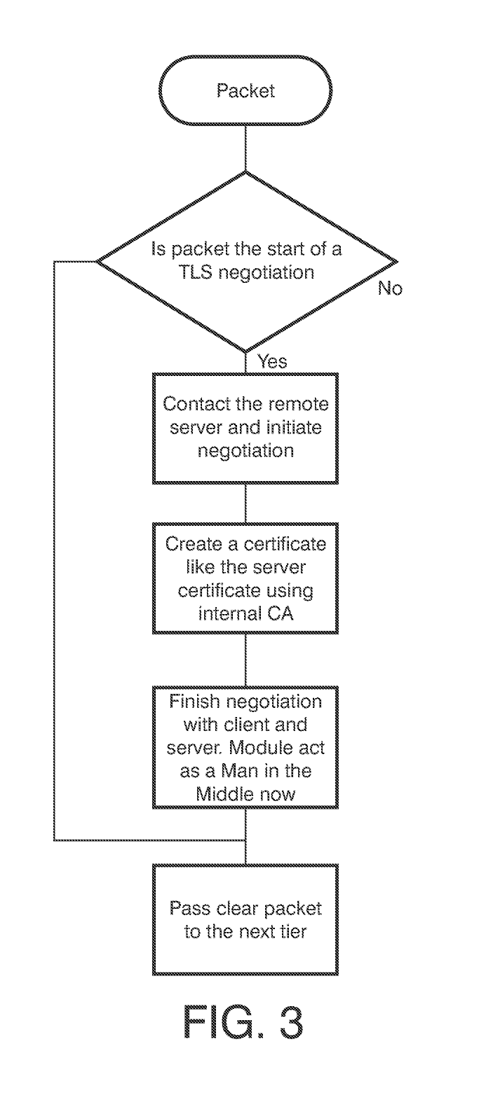

The way the module will work is as follows (FIG. 3):

Raw network packets will be analyzed. If a SSL/TLS connection is detected, then the module will act as a man-in-the-middle for the communication. To this extent, the module requires a Certificate Authority (CA) Certificate and key pair. This certificate will be created during System-H initial setup and should be installed on all client PCs (or they'll get a warning during TLS initial negotiation). The module will contact the remote point (server) of the connection and get its certificate. It will then, using the internal Certificate Authority certificate and key pair generate an identical certificate, which will be presented to the client PC. This way, the SSL tunneling module can act as a SSL proxy or man in the middle for the encrypted connections. SSL Tunneling will pass the on-the-clear packets (either because they weren't ciphered to start with or because they've been deciphered by the SSL Tunneling module) to the next tier/module (Pluggable Protocol Analyzer).

### Pluggable Protocol Analyzer.

This module will implement a network protocol analyzer. New network protocols can be added to System-H just by implementing a specific analyzer plug-in for it. Initially defined protocols include HTTP, XMPP/Jabber, IRC and RVP

This module will implement the following functions:
1. It will remove the protocol headers, extracting only the communication payload.
2. It will aggregate network packets until a communication element (CE) is composed. What exactly constitutes a ‘communication element’ depends on the underlying protocol. For example, for HTTP a communication element is a request (URL plus attached data) or a complete received element for any request (HTML page, image, object).
3. Once a complete communication element is composed, it will pass it to the content analyzer (both static content and dynamic content).

### Content Analyzer.

This module will perform analysis on the communications elements. The analysis will be as follows:
Determine the type of communication element.
Extract the identities from the communication element, if they are included. For example, if the communication element is a chat message, extract the senders' and the recipients' identities.
Invoke the adequate static content pluggable analyzers and dynamic content pluggable analyzers, if there's a defined analyzer for the type of communication element.
Pass the captured identities to the Network Identity Manager Module
If the analyzers raised any alarm, pass it to the Alarm Generator Module.

### Static Content Pluggable Analyzer.

This module will analyze communication elements searching for static patterns. A static content plug-in may be defined for each type of communication element. The minimal implementation will include analyzers for images, clear Text, HTML pages and chat messages.

The analysis realized by these modules will be restricted to searching for static patterns (like words, or numbers) on the communication elements analyzed. If a patter is found on the content, then a ‘User Restricted Element found’ is raised. This kind of analyzer will be used to detect, for example, forbidden or restricted URLs or forbidden keywords. For example, addresses, phone numbers, real life names, etc.

### Dynamic Content Pluggable Analyzer.

This module will analyze communications elements using a natural language analysis. Over the analyzed data, any kind of inference might be run. The minimal initial implementation will include the following analyzers:
Age analyzer. This module will assign a age range to each participant on a conversation. If a disparity of ages is found (a underage minor talking with an adult, for example) then a ‘Age difference’ alarm will be raised.
Harassment module. This module will identify harassment analyzing the conversation elements. If harassment is detected, then a ‘Harassment detected’ alarm will be raised.

### Network Identity Manager.

This module will keep tabs on all the identities detected by System-H. For any identity, it will request more information using the Identity Information Requestor Module. It will keep a network-of-connections for each identity. This way, the identities will be related amongst them if a direct communication has been detected by System-H (or reported by System-S via the Identity Information Requestor Module). It will also raise an ‘Internal Identity detected externally’ alarm if System-S reports than a previously known internal identity has been detected on an external connection.

### Identity Information Requestor.

This module will act as an interface with System-S. It will request information from external identities, and it will receive information when an internal identity has been detected externally.

### Alarm Generator Module.

This module will generate out-of-band alarms. An initially defined alarm channel will be an SMS to a mobile phone associated to the user's account.

The type of alarms generated depends on which content analyzer modules are present. Initially defined alarms include:
Internal Identity detected externally alarm, if System-S reports than a previously known internal identity has been detected on an external connection
‘Harassment detected’, generated by the dynamic harassment analyzer module.
‘Age difference’, generated by the dynamic age analyzer module.
‘User restricted element found’, generated by the static analyzer module.

System-S can comprise the following elements:

### Identity Information Request Service.

This module will act as interface with System-H modules. It will be the access point for System-H modules to request more information about identities.

### Identity Anomaly Detector.

This module will identify identities' anomalies, and act as the emanating point to report anomalies to the System-H modules. An identity anomaly, as initially deployed, happens when a identity that has been reported as ‘internal’ for a given System-H is reported as ‘internal’ by another System-H module, or is reported as ‘external’ by another System-H module without the parent System-H module having reported it as being present. That is, this module detects when any identity is used out of its normal home.

When an anomaly is detected, this module will contact the System-H marked as ‘owner’ of the identity.

### Anonymized Identity Network Storage.

This is the module charged with storing anonymized identities. For each identity, the following data will be stored:
Hash of the identity (so forward inference is possible, but backwards inference isn't).
List of hashes of related identities. Two identities are related if they have established some kind of communication in the past. For each related identity, the date of the last known communication will be also stored.
Owner System-H. The first System-H that reports any identity as ‘internal’ will be marked as owner of that identity.
Estimated age of the identity user, if reported by the System-H.

The system of the invention is specially useful for controlling children's internet interactions, and allows users to effectively know who their dependents are communicating with and what sites they're visiting; to automatically get alarms whenever their dependents engage on some kind of dangerous activity, as defined by the responsible person; to have a centralized place on which they can control the online activity of their dependents and get warnings whenever their dependents access the network from outside a controlled location (when they establish communication with any user inside of the system boundary).

In this text, the term “comprises” and its derivations (such as “comprising”, etc.) should not be understood in an excluding sense, that is, these terms should not be interpreted as excluding the possibility that what is described and defined may include further elements, steps, etc. On the other hand, the invention is obviously not limited to the specific embodiment(s) described herein, but also encompasses any variations that may be considered by any person skilled in the art within the general scope of the invention as defined in the claims.

1. A system for monitoring online communications of at least one LAN user, the system comprising:
a central communications server and locally deployed equipment in the user's home LAN, the locally deployed equipment comprising means adapted to:
automatically enumerate and store all the peers of the local user,
analyze natural language of the conversations between the user and the peers to assign an age range of the peers through morphological and syntactical language use, and
identify customer-specified words and generate a network of peers and alarms for users according to previously determined rules;
wherein the central communications server includes means to collect anonymized data from the pairs.

2. A system according to claim 1, wherein:
the locally deployed equipment is comprised of hardware and software adapted to:
implement a web user interface to allow the administration, customization and exploitation of gathered data from the communications;
intercept all network communication passing thorough it;
analyze network protocols;
search for specific keywords of the content;
perform natural language analysis of the content to detect dangerous or forbidden content;
detect if a peer is included on a list; and
act as man-in-the-middle for encrypted communications, allowing its analysis this way;
and the central communications system is provided with hardware and software adapted to:
act as a communication hub for the locally deployed equipment;
request information about any detected identity; and
collect anonymized information from pairs of users that have communicated in the past.

3. A system according to claim 1, wherein the central server further comprises means for detecting when a user is accessing the network from a location different than the computer comprising the locally deployed equipment.

4. A system according to claim 2, wherein the central server further comprises means for detecting when a user is accessing the network from a location different than the computer comprising the locally deployed equipment.
